(19) United States
(12) Patent Application Publication
(10) Pub. No.: US 2018/0266708 A1
(43) Pub. Date: Sep. 20, 2018

(54) SYSTEM AND METHOD FOR HIGH-EFFICIENCY ATMOSPHERIC WATER GENERATOR AND DEHUMIDIFICATION APPARATUS

(71) Applicant: WATER-GEN LTD., Rishon-Lezion (IL)

(72) Inventors: Sharon DULBERG, Beer Sheva (IL); Arye KOHAVI, Neve Monosson (IL)

(21) Appl. No.: 15/460,471

(22) Filed: Mar. 16, 2017

(51) Int. Cl. F24F 3/153; F24F 13/22; F24F 3/14; B01D 53/26

(52) U.S. Cl. CPC F24F 3/153; F24F 13/222; F24F 2003/1446; B01D 53/265; F24F 3/1405

(57) ABSTRACT

A dehumidifier apparatus comprising a duct, a cooled by external cooling fluid, at least first pre-cooling and second heat exchangers located upstream of said cooled core, at least second and first post heating heat exchanger located downstream of said cooled core heat exchanger, a first and second heat exchanging fluids circulating each between its corresponding pre-cooling and post heating heat exchangers. The heat exchanging fluids are designated to convey heat absorbed in the respective pre-cooling heat exchanger toward the corresponding post heating heat exchanger, to emit heat in the corresponding post heating heat exchanger and to flow back to the pre-cooling heat exchanger.

### BACKGROUND OF THE INVENTION

The performance evaluation of dehumidifiers and water extracting devices (hereinafter referred to as dehumidifiers) may be done based on several parameters, such as their physical size, their ability to reduce the absolute humidity content in the treated air, the rate of water extraction and the like. One performance evaluation parameter that has significant importance is the amount of energy used for extracting a given amount of water from the treated air. Second important parameter is the simplicity of the dehumidifier which may affect, among other parameters, its price and its maintainability. Those two last parameters are even more important when large scale dehumidifiers (that extract more than 180 liters of water per day) are at stake.

### SUMMARY OF THE INVENTION

A dehumidifier apparatus is disclosed comprising a duct to direct an air flow, with an air inlet and with an air outlet, a cooled core heat exchanger located within said duct and cooled by external cooling fluid, at least a first pre-cooling heat exchanger located upstream said cooled core, at least a second pre-cooling heat exchanger located upstream said first pre-cooling heat exchanger with average temperature higher than the average temperature of said first pre-cooling heat exchanger, at least a second post heating heat exchanger located downstream of said first post heating heat exchanger with average temperature higher than the average temperature of said first post-heating heat exchanger, a first heat exchanging fluid designated to flow from said first pre-cooling heat exchanger, adapted to convey heat absorbed in the first pre-cooling heat exchanger toward the first post heating heat exchanger, to emit heat in the first post heating heat exchanger and to flow back to the first pre-cooling heat exchanger, and a second heat exchanging fluid, designated to flow from said second pre-cooling heat exchanger adapted to convey heat absorbed in the second pre-cooling heat exchanger, toward the second post heating heat exchanger, and to emit heat in the second post heating heat exchanger, and to flow back to the second pre-cooling heat exchanger. Each one of the first and second heat exchanging fluids absorbs heat while flowing through a pre-cooling heat exchanger and emits heat while it flows through a post heating heat exchanger.

According to some embodiments, the motivating means for motivating at least one of the external cooling fluid and any of the first and second heat exchanging fluids is one of a pump and a compressor.

According to some embodiments, the motivating means for motivating air through the dehumidifier apparatus is a fan.

According to some embodiments, the heat exchanging fluid is a refrigerant which is adapted to boil in a pre-cooling heat exchanger and to liquefy in the corresponding post-heating heat exchanger.

According to some embodiments, the at least one of the heat exchangers is of the tube-and-fins type.

According to some embodiments, the dehumidifier apparatus further comprises a storage tank to hold heat-exchanging fluid, adapted to compensate volumetric changes in the heat exchanging fluid.

According to some embodiments, the dehumidifier apparatus further comprises an air cage in which air mixed with the heat exchanging fluid can be separated from said fluid.

According to some embodiments, the external cooling fluid source is a vapor-compression refrigeration system wherein the condenser of said vapor-compression refrigeration system is located downstream said second post-heating heat exchanger.

According to some embodiments, the dehumidifier apparatus further comprises a collection sump located at least below the cooled core adapted to collect water extracted from the air in the dehumidifier.

A method for dehumidifying air is disclosed comprising urging air via second pre-cooling heat exchanger, then through first pre-cooling heat exchanger which its average temperature is lower than said second pre-cooling heat exchanger, flowing the air from said first pre-cooling heat exchangers through a cooled core heat exchanger, flowing the air from the cooled core heat exchanger through first post-heating heat exchanger, then through second post-heating heat exchangers, wherein the second pre-cooling heat exchanger and the second post-heating heat exchanger are connected in a second heat exchanging fluid which flows from the second pre-cooling heat exchanger to the second post-heating heat exchanger and back, and wherein the first pre-cooling heat exchanger and the first post-heating heat exchanger are connected in a first heat exchanging fluid loop, which flows from the first pre-cooling heat exchanger to the first post-heating heat exchanger and back.

According to some embodiments, the urging of the air is by a fan.

According to some embodiments, the method for dehumidifying air at least one of the external cooling fluid and any of the first and second heat exchanging fluids is motivated in the heat exchanging fluid loop by one of a pump and a compressor.

According to some embodiments, the heat exchanging fluid is a refrigerant which is adapted to boil in a pre-cooling heat exchanger and to liquefy in the pair post-heating heat exchanger.

According to some embodiments, at least one of the heat exchangers is of the tube-and-fins type.

According to some embodiments, the method for dehumidifying air further comprises collecting at least some of the extracted water in the dehumidifier using a water sump.

According to some embodiments, the dehumidifier comprises a collection sump located at the lower part of the de-humidifier and at least adjacent to the cooled core adapted to collect water extracted from the air in the de-humidifier.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A schematically depicts dehumidification apparatus, according to embodiments of the present invention;

FIG. 1B is a schematic illustration of heat exchanging loop as is known in the art;

FIG. 1C schematically presents coolant loop with bleeding assembly 1550, according to embodiments of the present invention;

FIG. 1D is a schematic block diagram of a control system, for controlling a system for efficient dehumidification, according to embodiments of the present invention;

FIG. 2A is a psychrometric chart presenting the energetic operation of a heat exchanger with only cooled core unit and condenser unit, as is known in the art;

FIG. 2B depicts a temperature distribution along the dehumidifier described in FIG. 2A;

FIG. 2C is a chart presenting the performance of the dehumidifier described in FIG. 2A, as is known in the art;

FIG. 3A is a psychrometric chart presenting the energetic operation of a heat exchanger with cooled core unit, condenser unit and one pair of pre-cooler and post-heater, as is known in the art;

FIG. 3B depicts a temperature distribution along a dehumidifier described in FIG. 3A;

FIG. 3C is a chart presenting the performance of the dehumidifier described in FIG. 3A, as is known in the art;

FIG. 4A is a psychrometric chart presenting the energetic operation of a heat exchanger with cooled core unit, condenser unit and two pairs of pre-cooler and post-heater, according to embodiments of the invention;

FIG. 4B depicts a temperature distribution along a dehumidifier described in FIG. 4A;

FIG. 4C is a chart presenting the performance of the dehumidifier described in FIG. 4A;

FIG. 5A is a psychrometric chart presenting the energetic operation of a heat exchanger with cooled core unit, condenser unit and three pairs of pre-cooler and post-heater, according to embodiments of the invention;

FIG. 5B depicts a temperature distribution along a dehumidifier described in FIG. 5A;

FIG. 5C is a chart presenting the performance of the dehumidifier described in FIG. 5A;

FIGS. 6A and 6B are two parts of a flow diagram depicting an example of a method for controlling the operation of a dehumidification apparatus according to embodiments of the present invention; and

FIGS. 7A and 7B are two parts of a flow diagram depicting another example of a method for controlling the operation of a dehumidification apparatus according to embodiments of the present invention.

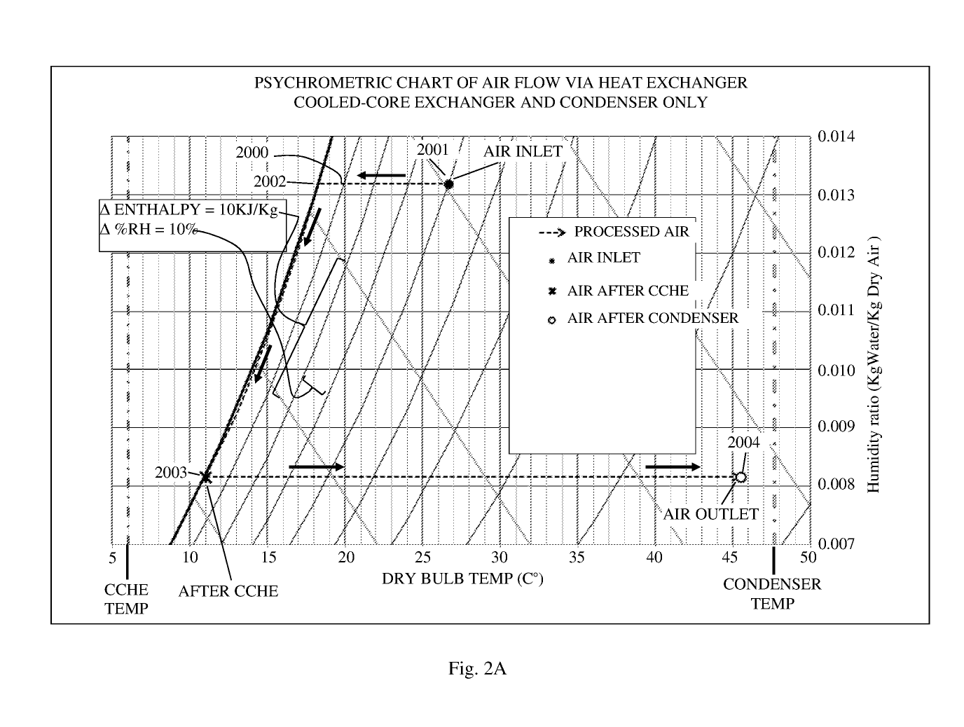

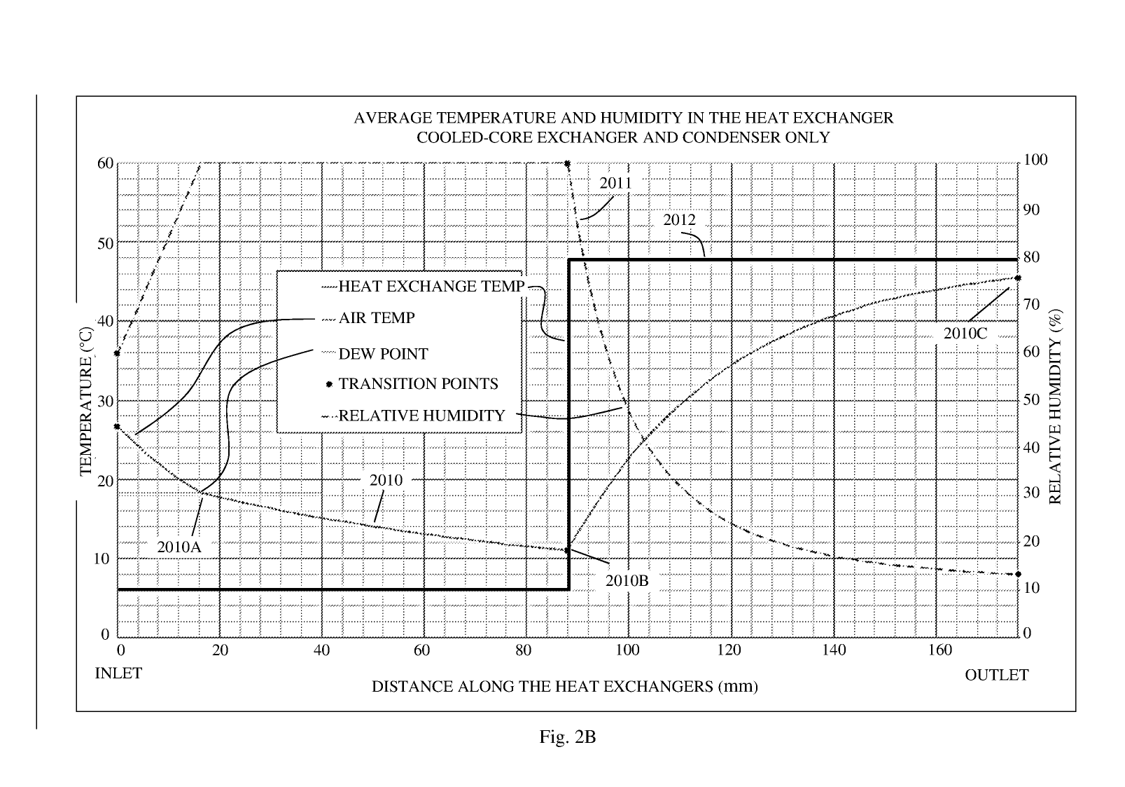

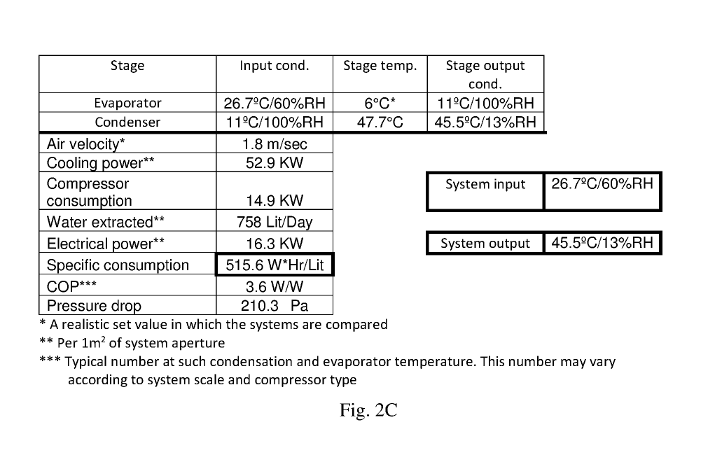

It will be appreciated that, for simplicity and clarity of illustration, elements shown in the figures have not necessarily been drawn to scale. For example, the dimensions of some of the elements may be exaggerated relative to other elements for clarity. Numbers indicating physical distances in FIG. 2B, 3B, 4B, and 5B are given for demonstration, and physical spaces between heat exchangers may be different. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

According to some embodiments of the invention, efficient dehumidification of a flow/stream of gas, such as air, is enabled using multiple stages of pre-cooling, and post heating should better be disposed symmetrically upstream and downstream of a cooled core, as is described in detail hereunder. Symmetrically, as used here, refers to the symmetric order of pre-coolers and post-heaters, that is a pair of pre-cooling heat exchanger and post-heating heat exchanger are disposed upstream and downstream of the cooled core heat exchanger, respectively, so that the pre-cooling heat exchanger is upstream of and closest to the cooled core heat exchanger, is paired with a coolant flowing in a closed cycle with a post-heating heat exchanger located closest to and downstream from the cooled core heat exchanger and so on, while the exact distance of either of the pre-cooler and post-heater from the cooled core heat exchanger is of less importance if at all. Such embodiments of the present invention are very useful, for example, for extracting, or generating water from atmospheric air.

In that way, in each pair of pre-cooler and post-heater, the average coolant temperature is different from any other pair. Accordingly, the pre-cooling heat exchangers may gradually cool down the airflow flowing towards the cooled core heat exchanger, which causes the heat exchanging efficiency to increase. The theoretical limit of the performance of a large number of pairs of pre-coolers and post heaters is similar to a counter-flow heat exchanger arrangement, yet the construction of a system according to the present invention in most cases can be simpler and cheaper.

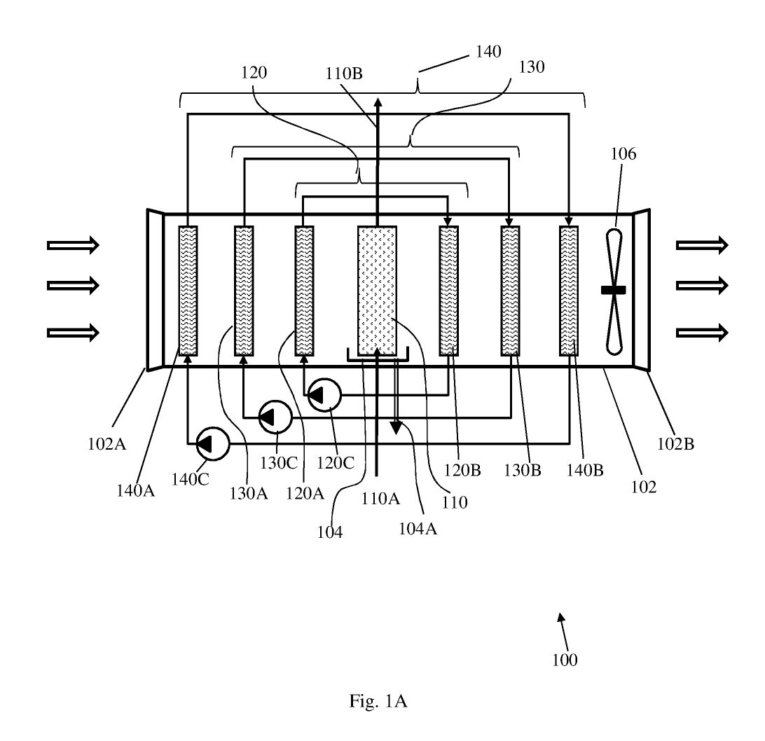

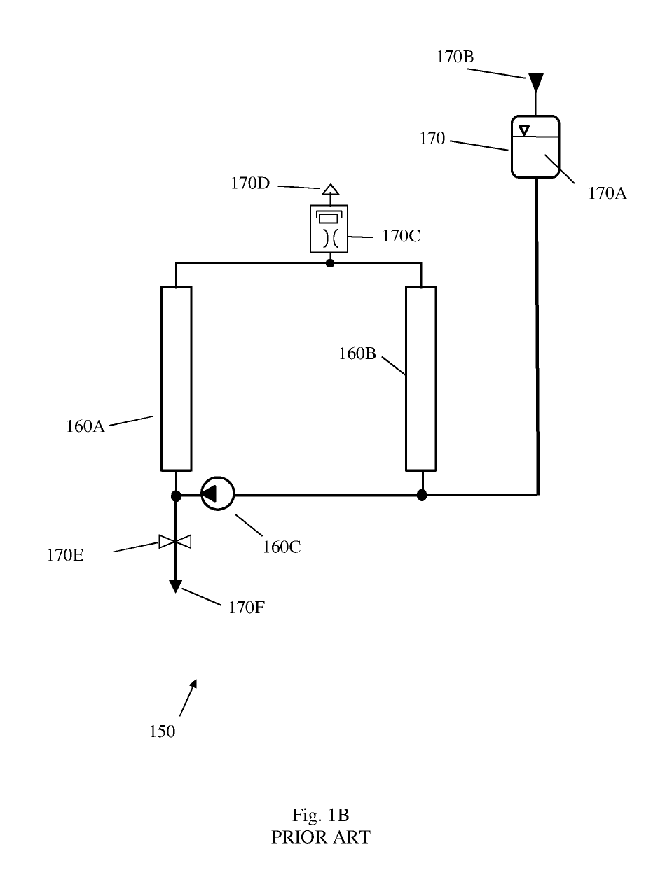

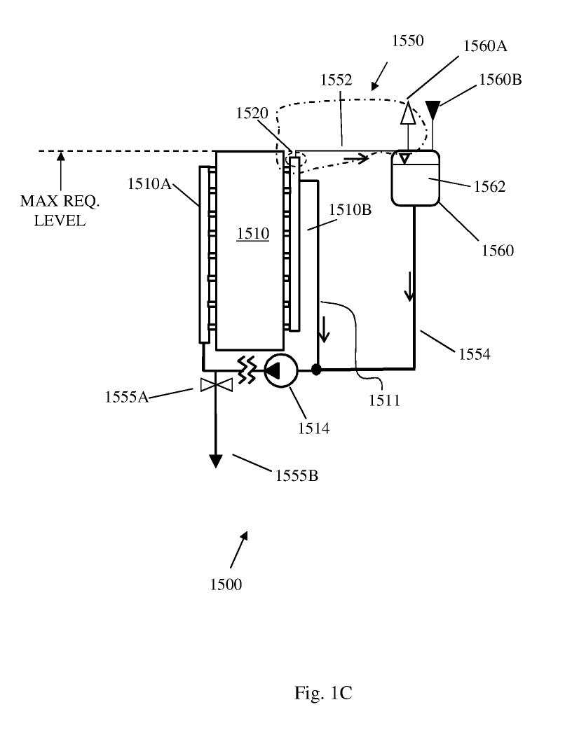

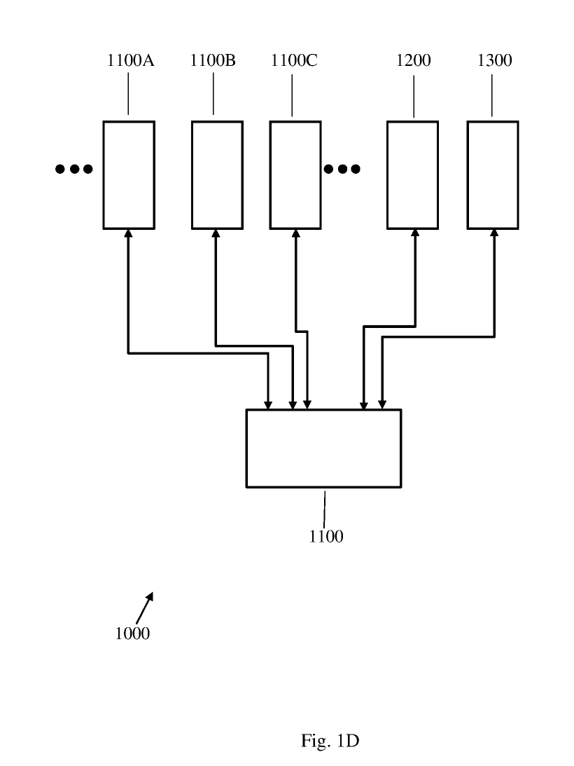

Reference is made to FIG. 1A, which schematically depicts dehumidification apparatus 100, according to some embodiments of the present invention. Dehumidification apparatus (DH) 100 may comprise duct 102 to direct air flow through it (from left to right in FIG. 1A), with inlet 102A and outlet 102B. At least one cooled core heat exchanger (CCHE) 110 is disposed in the way of the air flow. Further, three pairs of exchangers are positioned in the way of the airflow, each pair contains of a pre-cooling heat exchanger (PCHE) and corresponding post-heating heat exchanger (PHHE) that are communicating with each other. The first pair (120) is positioned closer to and upstream the air flow to the CCHE and downstream of same, respectively, the second pair (130) is positioned further from the CCHE and upstream and downstream the CCHE, and the third pair is positioned further away from the CCHE and upstream and downstream the CCHE, as is explained in details further below. As explained above, each PCHE and its corresponding PHHE are disposed in the way of the air flow in a symmetric sequence (not necessarily in a symmetric distance) with respect to CCHE 110 and are connected in a circulating coolant loop.

The dehumidification apparatus 100 in FIG. 1A contains three pairs of CCHE and PHHE: first pair 120, second pair 130, and third pair 140. Each pair contains PCHE and PHHE communicating with each other by a coolant circulation loop, adapted to reduce the temperature difference between them.

First pair's PCHE 120A is located closest to and upstream of CCHE 110, and first pair's PHHE 120B is located closest to and downstream of CCHE 110.

Second pair's PCHE 130A is located upstream of and second from CCHE 110, and second pair's PHHE 130B is located downstream of and second from CCHE 110.

Third pair's PCHE 140A is located upstream of and third from CCHE 110, and third pair's PHHE 140B is located downstream of and third from CCHE 110.

It will be appreciated by those skilled in the art that blower 106, adapted to urge stream of fluid, such as air, gas or gas mixture (hereinafter denoted ‘air’), via the various heat exchangers, may be located in other locations along the air flow path, or may be completely eliminated where spontaneous flow is available. Similarly, other elements, such as filters, may be used as may be desired and as is known in the art.

In some embodiments of present invention, fourth, fifth and more pairs of pre-cooling and post-heating heat exchangers may be added. It will, however, be apparent to those skilled in the art that the actual number of pairs of PCHE and PHHE may be selected to meet design requirements, as is explained hereinbelow.

Each pair of PCHE and PHHE is sharing common heat exchanging fluid coolant cycle, which is, according to some embodiments of the present invention different from the other pairs' cycles. Thus, the coolant fluid is flowing through one PCHE, reaching its corresponding PHHE and then returns to the same PCHE. In order to motivate the coolant in this cycle, a motivating device such as a pump, blower or the like may be used. In the first cycle, pump 120C is installed; in the second cycle, pump 130C is installed; and in the third cycle, pump 140C is installed.

In some embodiments of the present invention, the pump is a compressor urging the fluid in the other direction relative to that indicated in the diagram, the coolant is a refrigerant, the PCHE is the evaporator, the PHHE is the condenser, and all form a refrigeration cycle. In that case, an expansion valve should be used downstream of the coolant exit of the PHHE and upstream of the coolant exit of the PCHE (not shown in the diagram).

In some embodiments of present invention, no motivation device is used, and the circulation may be done, for example, by gravity, by locating the PCHE physically below the PHHE and allowing the coolant to exit at the top part of the PCHE into the top part of the PHHE and allowing the coolant to return from the bottom part of the PHHE to the bottom part of the PCHE. In such case, the densities difference of the coolant may motivate the circulation.

In some embodiments of present invention, the flow of the heat exchanging fluid may be controlled by a pump, a valve or any other suitable device. In some cases, the control can reduce the flow to minimum and even cease it altogether when the operation of the specific pair needs to be reduced or shut down completely. In some embodiments of the present invention, the coolant can stay in one phase (gas or liquid), and in other embodiments, a refrigerant can be used as a coolant, so it can change its phase during heating from liquid to gas, and during cooling from gas to liquid, as in heat pipe, as is known in the art.

According to some embodiments, at least one heat exchanging cycle may further comprise a compensation reservoir to compensate for volumetric changes of the heat exchanging fluid during operation of the system, as is explained in detail with respect to FIG. 1B, which is schematic illustration of heat exchanging loop 150 as is known in the art.

As is evident from the description above, air entering the dehumidification apparatus is gradually cooled when passing through each stage of PCHE by transferring heat to the heat exchanging fluid flowing in the PCHE Similarly, air passing through each PHHE downstream of the CCHE unit is gradually heated by heat transferred to the air from the heat exchanging fluid flowing through the post-heating heat exchanger and, at the same time, cools down that fluid.

Humid air may be motivated via duct 102, from inlet 102A towards outlet 102B, for example by means of blower 106. Blower 106 is drawn disposed close to outlet 102B of duct 102. However, it will be apparent that it may be disposed in other locations, such as close to inlet 102A or in any other location along the flow path of air in duct 102. According to some embodiments, a plurality of blowers may be used, disposed along the air flow path in duct 102. The selection of the number of blowers and their location may be subject to various considerations, such as the available installation space, external installation constrains, energetic calculations, and the like. In some embodiments, the blower may be located outside the apparatus, and in some embodiments, the blower may not be required at all, such as where strong enough is available, for example in a wind tunnel like or where a chimney effect tunnel exists.

Water sump 104 may be disposed close to or inside duct 102, adapted to collect water draining from system 100. Typically, sump 104 may be installed under CCHE 110, because a large amount of water is expected to be extracted from the air flowing duct 102. However, sump 104 may be disposed, additionally, under other locations of duct 102, such as under some of the PCHEs, or under other locations as may be dictated by specific design constrains. Sump 104 may further comprise water outlet conduit 104A, which may be adapted to guide water collected from system 100 to water collecting or handling system (not shown). Accordingly, outlet conduit 104A may comprise a valve, a pump and additional water handling elements (not shown), as may be required and as is known in the art.

CCHE 110 is adapted to decrease the temperature of air flowing through it below its dew point. CCHE 110 may be fed with coolant that enters through coolant entry 110A and exits through coolant exit 110B. The coolant is adapted to serve in the designated temperature/range of temperatures and to be capable of exchanging the designated amount of heat per amount of air flowing through it, or according to any other guiding parameter. In some embodiments, CCHE 110 may be fed with coolant that may be received from natural resources, such as ocean deep-water.

In some embodiments of present invention, the coolant can stay in one phase (gas or liquid) through the entire operation cycle, and in other embodiments, a refrigerant can be used as a coolant, so it can change its phase during the passage in the CCHE from liquid to gas.

In some embodiments of present invention, the CCHE is the evaporator part of a vapor-compression refrigeration system (not shown in the figure). The refrigeration system may contain a compressor, a condenser, expansion device, etc., as is known in the art. The condenser (not shown in the figure), may preferably be located downstream of the last PHHE. The condenser may be located upstream of blower 106, downstream of blower 106, or may be cooled down by other means.

In some embodiments of the present invention, coolant used in at least one of the heat exchanging fluid of pairs 120, 130, 140 and/or in the CCHE 110 may have a freezing point below zero degrees centigrade.

In some embodiments of the present invention, at least one of the PCHE and/or PHHE and/or CCHE may contain air relief means (as is drawn and explained with regard to FIG. 1C) in order to allow accumulated or trapped air to escape from the heat exchanger flow cycle. In some embodiments of present invention, the air relief may be embodied by a controlled air release device or by a bleed means that allow small part of the heat exchanging fluid to circulate from the top of the heat exchanger toward a reservoir, driven, preferably but not necessarily, by the same motivation force that drives the heat exchanging fluid. The bleeding means assists to evacuate air, if it is present, from the inside of the heat exchanger with minor or none degradation of the performance of the heat exchanger. Moreover, using specially designed bleeder enables to use heat exchanger with height dimension almost completely unaffected by the bleeding system, where systems with prior art air bleeders usually require some of the height dimension be kept for the bleeder on the account of the heat exchanger.

Preferably, but not necessarily, the PCHEs, PHHEs and the CCHE units may be embodied as fins-and-tubes heat type heat exchanger. In some embodiments, at least some of the heat exchangers may be of another type, such as plates heat exchanger, tubular heat exchanger or any other type or combination that is suitable for the system's specific design requirements.

In some embodiments of the present invention, at least one air filter (not shown in the figure) may be disposed upstream of the CCHE in order to prevent particles of dust and/or sand from the approaching the heat exchangers and to thereby avoid polluting the condensed water and/or in order to prevent those particles from jam air flow through at least some of the heat exchangers.

The number of pairs of PCHE and PHHE installed in a specific dehumidification system, such as system 100, may be decided based on many alternative or cumulative considerations, such as, for example, the expected environmental conditions at the installation site; the efficiency required from the system; the cost of the system versus the cost of electricity in the installation site; the dimension limitations allowed in terms of transportation, installation and marketing, and the like.

Reference is made now to FIG. 1B, which schematically presents a prior art heat exchanging loop 150. Heat exchanging loop 150 is a schematic representation of any of the heat exchanging loops of first pair 120, second pair 130 or third pair 140 of FIG. 1A. Heat exchanging loop 150 comprise expansion/contraction compensation reservoir 170 adapted to contain certain amount of heat exchanging fluid usable in loop 150. Typically, changes of the fluid's average temperature along time may change its volume, so that it may expand, contract, or be lost due to leakage. Compensation reservoir 170 may be adapted to provide fluid to loop 150 or receive fluid from it, as may be required, by means of one or more known means and methods, such as pre-loaded pressure inside the reservoir (by pressurized gas, pre-loaded spring and the like), gravitational compensation, and the like. The reservoir may contain means to indicate one or more physical parameters, such as low fluid level, low pressure, high fluid level, fluid temperature, etc.

Air bleeding system known in the art, such bleeding valve 170C, 170D of FIG. 1B, requires that it will be installed at the highest point of the coolant cycle, to enable trapping air in the loop. This, in turn, requires that certain installation height will be reserved for the air bleeding valve, thus consuming height installation on the account of the heat exchangers, which is a disadvantage.

Reference is made to FIG. 1C, which schematically presents coolant loop 1500 with bleeding assembly 1550, according to some embodiments of the present invention. Bleeding assembly 1550 may be connected to heat exchanger 1510. Heat exchanger 1510 may have fluid motivating means 1514 adapted to urge coolant fluid to heat exchanger 1510 via its inlet manifold 1510A. Coolant fluid leaving heat exchanger 1510 via coolant outlet manifold 1510B may circulate back towards motivating means 1514 via return tube 1511. System drainage valve 1555A and drainage 1555B may enable draining of the system. Coolant outlet manifold 1510B may be equipped with air trap 1520 formed as cavity closed at its top part and connected to the coolant circulation loop. At the uppermost part of air trap 1520 cavity, a respectively thin air bleed pipe 1552 may be connected to fluid compensation tank 1560, preferably to its top portion. Compensation tank 1560 may be partially filled with coolant fluid 1562. Tank 1560 may further be equipped with refill inlet 1560B. The outlet of tank 1560 may be connected by tube 1554 to the coolant circulation loop. In routine operation, the entire system may be under pressure provided by motivating means 1514. Air bubbles that may be found in the coolant fluid may pass through outlet manifold 1510B and may be trapped in air trap 1520 due to their tendency to float up. Due to a difference in the diameter of bleed pipe 1552 and the diameter of return tube 1510B, which is larger, the flow rate via bleed pipe 1552 is smaller than the return flow rate. The differential in flow rates can also be achieved by using a restrictor, flow regulator and other means disposed on pipe 1552, means as are known in the art. Air bubbles trapped in air trap 1520 may be carried with the flow through bleed pipe 1552 and be poured into compensation tank 1560. Tank 1560 is provided with air bleed means 1560A, as is known in the art. In some embodiments of the present invention, an air bleeding valve may be installed on outlet 1560A, and a unidirectional valve can be installed on inlet 1560B which allow to located the compensation tank lower than the highest point of heat exchanger 1510. The air trap point 1520 may be located at the highest point of heat exchanger 1510, or close to it. Since the entire coolant loop 1500 operates under pressure, there is no need to locate air bleeding valve elements at the top of the heat exchanger.

Operation parameters of efficient dehumidification system, such as system 100, may be inlet air temperature, humidity and flow speed, temperature set at each pair of PCHE and PHHE, temperature set at the CCHE, circulation rate of the heat exchanging fluid in each pair of PCHE and PHHE, rate of providing of coolant to the CCHE, and the like. The setting of these parameters may be affected by, and be tuned to meet, variants such as incoming air temperature, relative humidity, availability of electrical power, required amount of extracted water, available installation space and the like.

Control parameters, which control the operation of a dehumidification system, such as system 100, may include actual temperature and/or humidity of air entering duct 102, flow speed of the air via duct 102, temperature of the heat exchanging fluid at the entry and/or outlet of a PCHE and/or of a PHHE and of the CCHE, the flow speed of the heat exchanging fluid and/or its pressure, power provided to blower 106, rate of water extraction measured, fluid existence in reservoirs, pressure drops upon air filters, temperature limit of some of the system elements, etc..

Reference is made now to FIG. 1D, which is a schematic block diagram of control system 1000 for controlling a system for efficient dehumidification such as system 100, according to embodiments of the present invention. Control system 1000 comprise central controller 1100, control units 1100A, 1100B and 1100C controlling each a heat exchanging loop, such as pairs 120, 130 and 140, control unit 1200 controlling the operation of a CCHE, such as CCHE 110 and control unit 1300 controlling the operation of air fan such as blower 106.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Controller 1100 may be, for example, a central processing unit processor (CPU), a chip or any suitable computing or computational device. Controller 1100 may comprise memory unit, storage unit, I/O unit and communication unit (none is shown in the drawing). Alternatively, Controller 1100 may be hydraulic, pneumatic or mechanical computation device(s).

The memory and/or the storage units may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 420 may be or may include a plurality of, possibly different memory units. The memory units may store executable code that, when executed by the controller, performs the operations and methods described herein. In some embodiments, the storage unit may be or may include, for example, a hard disk drive, a floppy disk drive, a Compact Disk (CD) drive, a CD-Recordable (CD-R) drive, a universal serial bus (USB) device or other suitable removable and/or fixed storage unit. Alternatively, memory device can be implemented in hydraulic, pneumatics or mechanic device(s).

Control units 1100A, 1100B and 1100C may comprise one or more of the following control means: temperature sensors to sense temperatures associated with the process, such as of the heat exchanging fluid at designated locations along the loop and air temperature at the inlet to the humidifier and optionally at additional locations, humidity sensors to sense air humidity at the inlet to the dehumidifier and optionally at additional locations, flow rate indicator(s) to indicate the rate of flow of the heat exchanging fluid at selected heat exchanging loops, flow rate sensor(s) to sense flow rate of the air flowing, for example, into and/or out of PCHE and/or PHHE of the loop, power sensor(s) to sense the power provided to, for example, the fluid pump of the loop, fluid level sensor(s) to sense fluid level in, for example, the compensation tanks, compressor RPM sensor, blower RPM sensor, and the like.

Control unit 1200 may comprise temperature sensor to sense the temperature the coolant provided to the CCHE, flow rate sensor to sense its flow rate, pressure sensor to sense it pressure, power indicator to indicate the power invested in circulating the coolant through the cooled core.

Control unit 1300 may comprise power sensor to sense the power provided to the air fan, air flow speed to sense the air flow speed through the fan.

For a dehumidification apparatus with a given number of pairs of PCHE and PHHE and a given duct dimensions and fan dimension, the control variables that may control its operation may comprise: designated temperature in each of PCHE and PHHE in each of the pairs. The actual temperature of the coolant and the respective PCHE and PHHE may hardly be controlled, since it is mainly a result of the air flow speed through the dehumidifier, its initial temperature and humidity, the set-point temperature of the CCHE and the cooling capacity of the refrigerator that cools it. Yet, the flow rate of the coolant fluid in each PCHE and PHHE and, in time of need, the flow of the coolant may be shut off.

When the number of the heat exchanging pairs and their operational nature may be selected by the designer, further design freedom is obtainable and the number of pairs, the cross-section size (aperture) and form of the air duct, the type of CCHE and the size and power of the fan may be selected to comply with the required performance of the dehumidification apparatus.

Computational operation of dehumidification apparatus was carried out using several versions of the apparatus—without a pair of PCHE and PHHE, i.e., with only CCHE and condenser; with a CCHE and a condenser and one pair of PCHE and PHHE; and with a CCHE and a condenser with both two and three pairs of PCHE and PHHE. The dehumidification results are summarized in charts in FIGS. 2A-2D.

The computation was made out by normalizing the machine aperture to 1 m², i.e., all PCHEs, CCHE, PHHEs and condenser has the same aperture size of 1 m², and the air flows laminarly through them. The parameters of the heat exchangers in the calculation are as follows:

| | | | Area perpendicular to | Tubes |
|---|---|---|---|---|
| Part | Fins density | Depth | the flow direction | type |
| PCHE | 16 fins per inch | 44 | 1 m² | ⅜″ |
| CCHE | 16 fins per inch | 88 | 1 m² | ⅜″ |
| PHHE | 16 fins per inch | 44 | 1 m² | ⅜″ |
| Condenser | 16 fins per inch | 88 | 1 m² | ⅜″ |

The compressor selected for this calculation was chosen to have such cooling power to provide CCHE temperature of 6° C. at each configuration. The COP vs. evaporating temperature and condensation temperature was normalized from few commercial compressors exists in the market. Each pump used for circulating the fluid (water in this example) in the pairs of heat exchangers is assumed to consume 360 W each, and the blower consume around 1.4 KW. The water temperature in a single pair is assumed to remain within ±0.3° C. and, because of that, the calculation neglect temperature differential inside a single pair.

Reference is made now to FIG. 2A, which is a psychrometric chart presenting some physical characteristic of the air flowing through a dehumidifier with only cooled core unit and condenser unit (i.e., no pre-cooling and post heating units), as is known in the art. Reference is also made to FIG. 2B which depicts a temperature and humidity distribution along a dehumidifier described in FIG. 2A and to FIG. 2C, which is a chart presenting the performance of the dehumidifier described in FIG. 2A, as is known in the art.

The graph of FIG. 2A describes the changes in temperature and humidity of air flowing through the dehumidifier. The horizontal axis represents dry bulb temperature in stages of 5° C. Meaningful temperatures are marked on the horizontal line: the CCHE temperature; and the condenser temperature. The vertical axis shows the humidity ratio of water, i.e., how many kilograms of water vapor exist in one kilogram of dry air. Diagonal lines across the chart from top-left to bottom-tight describe isenthalpic lines in a difference of 10 KJ/Kg between every two adjacent lines. The curved lines crossing the chart from top-right to bottom-left represent lines of relative humidity in a difference of 10% between each two adjacent lines. The left-most relative humidity line (bold line) represents the line of dew point.

As may be seen, the changes in temperature and humidity of the air flowing through the dehumidifier are represented by dashed line 2000 and begins at point 2001, where the air enters the dehumidifier. During the cooling, the humidity ratio remains constant (approx. 0.0132 Kg water/Kg Air). When the temperature of the air reaches the dew point (point 2002), the humidity ratio drops to approx. 0.0081, and when the airflow leaves the CCHE unit (point 2003), its temperature start rising as it flows through the condenser while the humidity ratio remains approx. 0.0081 until the temperature of the air reaches about 45.5° C.

In FIG. 2B, the horizontal axis describes locations along the air duct of the dehumidifier starting from left at the inlet and ending on the right at its outlet. The vertical left axis represents temperature (ranging from 0° C. to 60° C.). The vertical right axis represents relative humidity ranging from 0% to 100%. Graph 2010 presents the changes of temperature of the air as it flows through the dehumidifier, graph 2011 presents the changes in the humidity of the air as it flows through the dehumidifier, and graph 2012 presents the temperature distribution of heat exchangers along the dehumidifier. Although in practice there is a distance between the heat exchangers, they are omitted in the figure for simplicity. The temperature of the CCHE is approx. 6° C. Air enters the dehumidifier at temperature of about 26.7° C. and its average temperature drops gradually until it reaches the dew point 2011A (at approx. 18 mm from the entrance), and the rate of temperature reduction decreases. At a distance of 88 mm from the entrance, the air flow leaves the CCHE (point 2010B) at about 11° C. and enters the condenser. The temperature of the condenser is about 49° C. As a result, the temperature of the air flow starts rising until the air flow leaves the dehumidifier at point 2010C with temperature of about 45.5° C.

FIG. 2C presents the performance of a dehumidifier with only CCHE (evaporator) and a condenser, that is no pair of PCHE and PHHE are operating here, as is known in the art. In this chart, the upper half (the one above the thick black line) depicts operational information per stages in the dehumidification apparatus: in the vertical left-most column, the various stages of the dehumidification apparatus are listed, and in the upper-most line the operational variables used for reflecting the performance are listed. In the lower part of the chart, computational over-all performance details, at system level, are presented. A significant performance number is the efficiency of water extraction (expressed by Watt*Hour/Liter of water) shown in the box encircled with thick black line, which is in this example 515.6 Watt*Hour/Liter water.

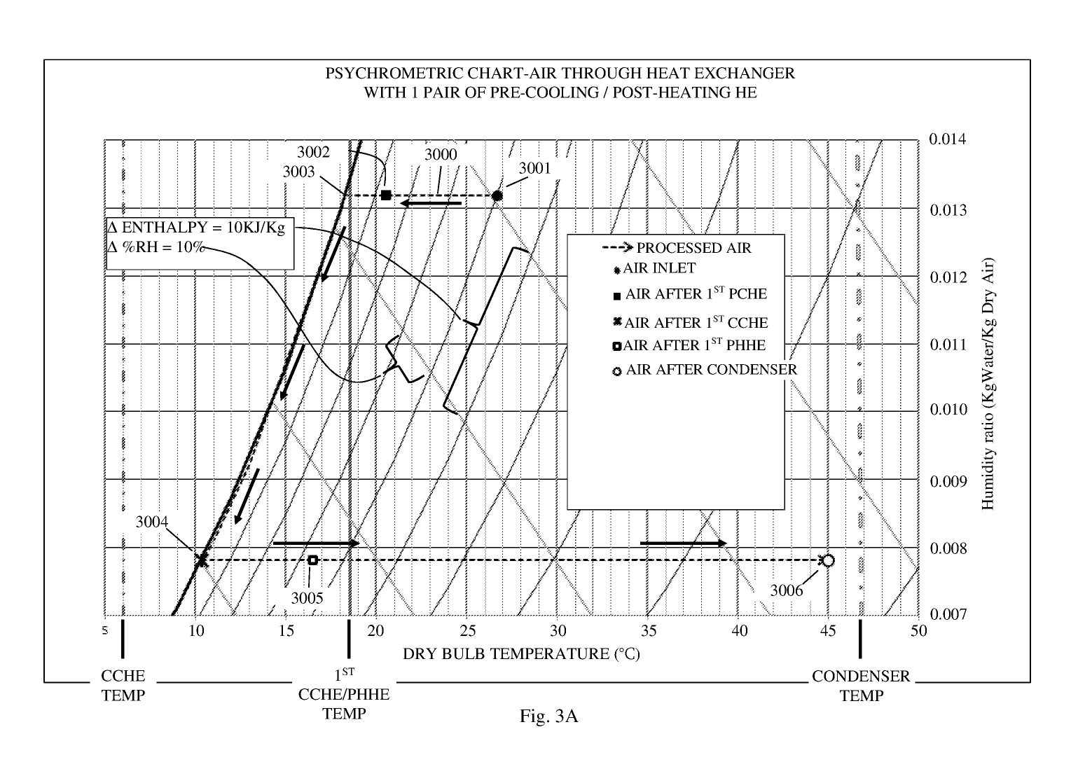

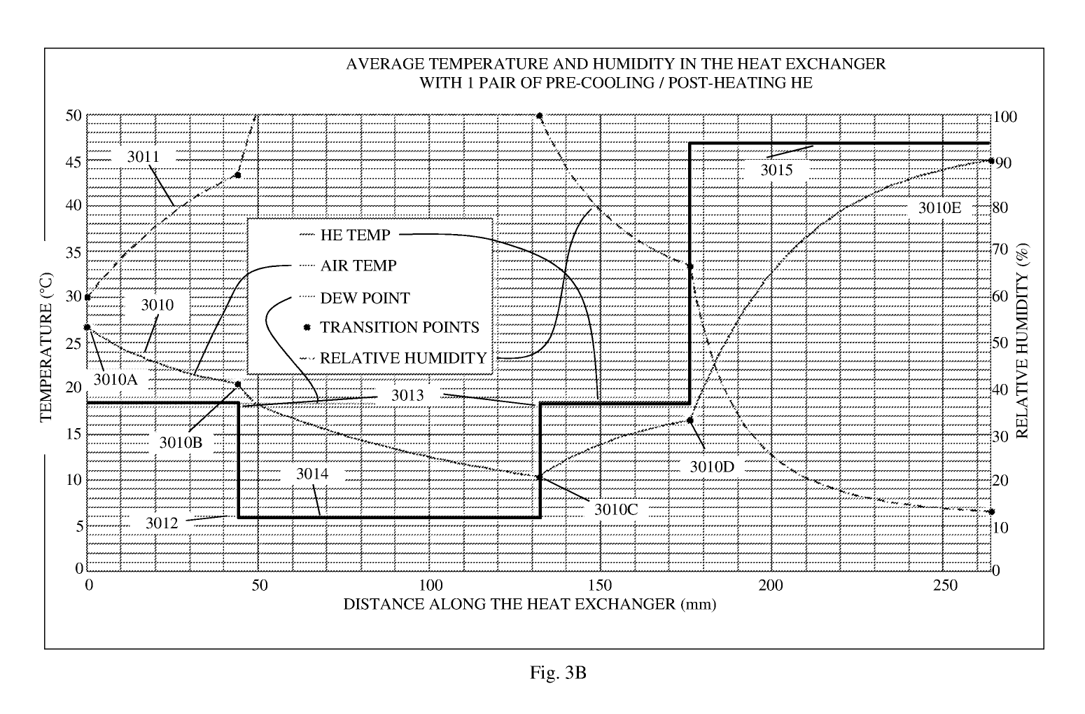

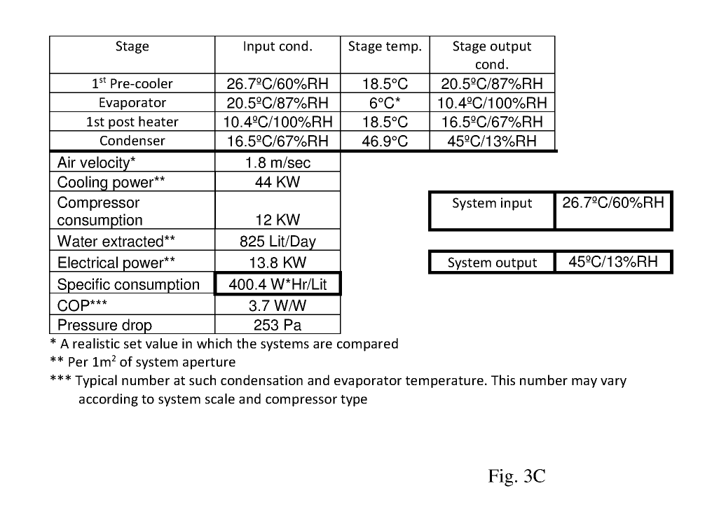

Reference is made now to FIG. 3A, which is a psychrometric chart presenting the some physical characteristic of the air flowing through dehumidifier with cooled core unit, condenser unit and one pair of pre-cooler and post-heater, as is known in the art. Reference is also made to FIG. 3B which depicts a temperature and humidity distribution along a dehumidifier described in FIG. 3A and to FIG. 3C, which is a chart presenting the performance of the dehumidifier described in FIG. 3A, as is known in the art.

The graph of FIG. 3A describes the changes in temperature and humidity of air flowing through the dehumidifier. The horizontal axis represents dry bulb temperature in stages of 5° C. Meaningful temperatures are marked on the horizontal line: the CCHE temperature (set to be 6° C.); the CCHE/PHHE pair temperature (approx. 18.5° C.), and the condenser temperature (approx. 46.9° C.). The vertical axis shows humidity ratio of water, i.e., how many kilograms of water vapor exist in one kilogram of dry air. Diagonal lines across the chart from top-left to bottom-tight describe isenthalpic lines in a difference of 10KJ/Kg between every two adjacent lines. The curved lines crossing the chart from top-right to bottom-left represent lines of relative humidity in a difference of 10% between each two adjacent lines. The left-most relative humidity line (bold line) represents the line of dew point.

As may be seen, the changes in temperature and humidity of the air flowing through the dehumidifier is represented by dashed line 3000 and begins at point 3001, where the air enters the dehumidifier. During the cooling the specific content of water remains constant (approx. 0.0132 Kg water/Kg Air). The air flows through the CCHE crossing point 3002 and reaches dew point (point 3003). The average temperature keeps decreasing (from about 18.3° C. to about 10.4° C.), and the humidity ratio drops to approx. 0.0078. The airflow leaves the CCHE unit (point 3004) at about and reaches PHHE where its temperature start raising to about 20.5° C./87 RH, when it flows through the condenser its temperature raises to about 45° C./13% RH (point 3006) and then it leaves the dehumidifier.

In FIG. 3B, the horizontal axis describes locations along the air duct of the dehumidifier starting from left at the inlet and ending on the right at its outlet. The vertical left axis represents temperature (ranging from 0° C. to 60° C.). The vertical right axis represents relative humidity ranging from 0% to 100%. Graph 3010 presents the changes of temperature of the air as it flows through the dehumidifier, graph 3011 presents the changes in the humidity of the air as it flows through the dehumidifier, and graph 3012 presents the temperature distribution of heat exchangers along the dehumidifier. The temperature of the PCHE/PHHE (3013) is about 18.5° C. The temperature of the CCHE (3014) is set to be 6° C. The temperature of the condenser (3015) is about 46.9° C.

Air enters the dehumidifier (point 3010A) at a temperature of about 26° C. and flows through the PCHE, where its temperature drops. At 44 mm, it leaves the PCHE at an average temperature of 20.5° C. and enters the CCHE. In the CCHE, the average air temperature decreases gradually until it reaches the dew point 3010B (at approx. 49 mm from the entrance) and the rate of temperature reduction decreases. The air flow temperature continues to drop while it flows through the CCHE until it reaches about 10.4° C. (point 3010C) at a distance of approx. 132 mm from the entrance. The air leaves the CCHE and flows through the PHHE (between points 3010C and 3010D), and its temperature rises to about 16.5° C. From here, the air flows through the condenser, and its temperature rises to about 45° C. when the air leaves the dehumidifier. The relative humidity, graph 3011, rises accordingly from about 60% at the entrance to about 87% when the air flows from the PCHE to the CCHE and remains 100% until the air leaves the CCHE. The relative humidity then drops to about 67% as the air flows through the PHHE and then to about 13% when it leaves the condenser.

FIG. 3C presents the performance of a dehumidifier with CCHE (evaporator), one pair of PCHE/PHHE and a condenser (that was presented in FIGS. 3A and 3B), as is known in the art. In this chart, the upper half (the one above the thick black line) depicts operational information per stages in the dehumidification apparatus: in the vertical left-most column, the various stages of the dehumidification apparatus are listed, and in the upper-most line, the operational variables used for reflecting the performance are listed. In the lower part of the chart, computational over-all performance details, at system level, are presented. A significant performance number is the efficiency of water extraction (expressed by Watt*Hour/Liter of water) shown in the box encircled with thick black line, which is in this example 400.4 Watt*Hour/Liter water.

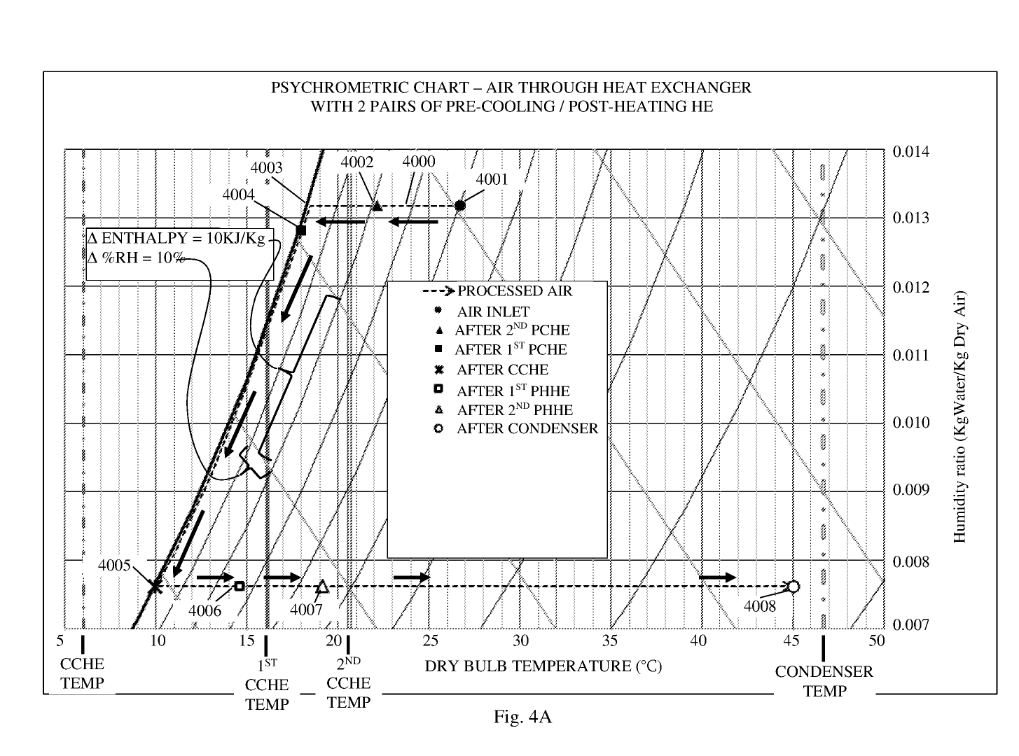

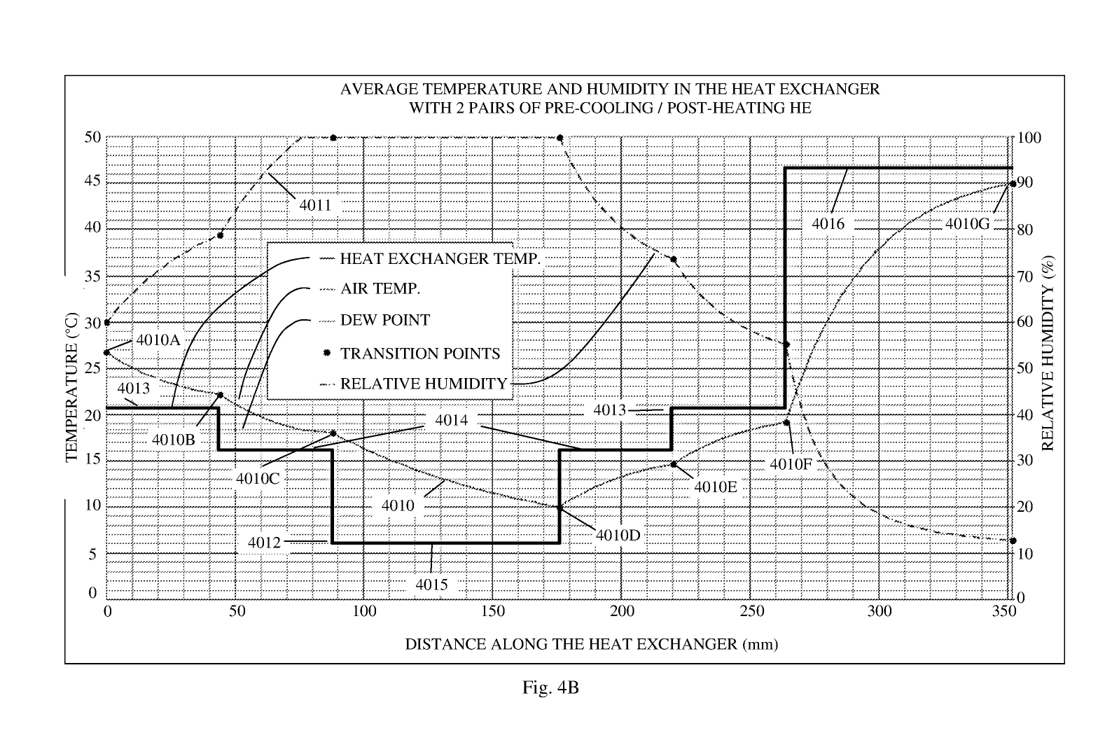

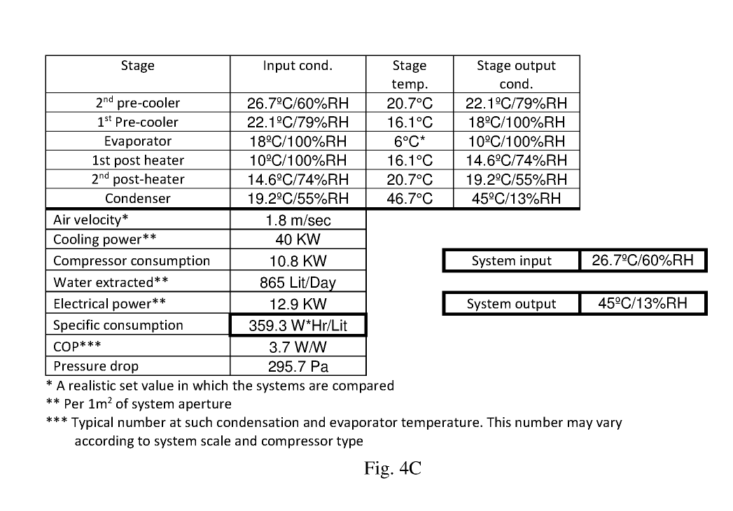

Reference is made now to FIG. 4A, which is a psychrometric chart presenting some physical characteristic of the air flowing through a dehumidifier with cooled core unit, condenser unit and two pairs of pre-cooler and post-heater, according to some embodiments of the invention. Reference is also made to FIG. 4B which depicts a temperature and humidity distribution along a dehumidifier described in FIG. 4A and to FIG. 4C, which is a chart presenting the performance of the dehumidifier described in FIG. 4A.

The graph of FIG. 4A describes the changes in temperature and humidity of air flowing through the dehumidifier. The horizontal axis represents dry bulb temperature in stages of 5° C. Meaningful temperatures are marked on the horizontal line: the CCHE temperature (set to be 6° C.); the first CCHE/PHHE pair temperature (approx. 16.1° C.); the second CCHE/PHHE pair temperature (approx. 20.7° C.); and the condenser temperature (approx. 46.7° C.). The vertical axis shows the humidity ratio of water, i.e., how many kilograms of water vapor exist in one kilogram of dry. Diagonal lines across the chart from top-left to bottom-tight describe isenthalpic lines in a difference of 10 KJ/Kg between every two adjacent lines. The curved lines crossing the chart from top-right to bottom-left represent lines of relative humidity in a difference of 10% between each two adjacent lines. The left-most relative humidity line (bold line) represents the line of dew point.

As may be seen, the changes in temperature and humidity of the air flowing through the dehumidifier is represented by dashed line 4000 that begins at point 4001, where the air enters the dehumidifier at 26.7° C./60% RH. During the cooling, the specific content of water remains constant (approx. 0.0132 Kg water/Kg Air). The air flows through the second CCHE crossing point 4002 and reaches dew point at 18.3° C. (point 4003). The temperature keeps decreasing (from about 18.3° C. to about 11° C.), and, when the temperature crosses point 4004, it enters the first PCHE, and the temperature continues to drop and the specific content of water in air drops to approx. 0.0077 as the air flows through the CCHE. The airflow leaves the CCHE unit at 10° C. (point 4005) and reaches first PHHE where its temperature starts rising to 14.6° C./74% RH (point 4006). The air flows through the second PHHE, leaves it at 19.2° C./55 RH (point 4007), then through the condenser where its temperature rises to about 45° C./13% RH (point 4008) and leaves the dehumidifier.

In FIG. 4B, the horizontal axis describes locations along the air duct of the dehumidifier starting from left at the inlet and ending on the right at its outlet. The vertical left axis represents temperature (ranging from 0° C. to 50° C.). The vertical right axis represents relative humidity ranging from 0% to 100%. Graph 4010 presents the changes of temperature of the air as it flows through the dehumidifier, graph 4011 presents the changes in the humidity of the air as it flows through the dehumidifier, and graph 4012 presents the temperature distribution of heat exchangers along the dehumidifier. The temperature of the second PCHE/PHHE (4013) is about 20.7° C. The temperature of the first PCHE/PHHE (4014) is about 16.1° C. The temperature of the CCHE (4015) is approx. 6° C. The temperature of the condenser (4016) is about 46.7° C.

Air enters the dehumidifier (point 4010A) at temperature of about 26° C., and its temperature drops gradually to temperature of about 22.1° C. (point 4010B) as it leaves the second PCHE and flows to the first PCHE until it reaches the dew point 4010C (at approx. 72 mm from the entrance) and the rate of temperature reduction decreases. The air flow flows through the CCHE, and the temperature continues to drop until it reaches about 10° C. (point 4010D) at a distance of approx. 176 mm from the entrance. The air leaves the CCHE and flows through the first PHHE (between points 4011D and 4010E), and its temperature rises to about 14.6° C. From here, the air flows through the second PHHE from point 4010E to point 4010F, and its temperature rises to about 19.2° C. and then to the condenser and its temperature rises to about 45° C. at point 4010G when the air leaves the dehumidifier. The relative humidity, graph 4011, rises accordingly from about 60% at the entrance, to about 79% when the air flows from the second PCHE to the first PCHE and then rises further to 100% when the air flows through the CCHE and remains 100% until the air leaves the CCHE. The relative humidity drops to about 74% as the air exits the first PHHE and then to about 55% as it exits the second PHHE and to 13% when it leaves the condenser.

FIG. 4C presents the performance of a dehumidifier with CCHE (evaporator), two pairs of PCHE/PHHEs and a condenser (that was presented in FIGS. 4A and 4B). In this chart, the upper half (the one above the thick black line) depicts operational information per stages in the dehumidification apparatus: in the vertical left-most column, the various stages of the dehumidification apparatus are listed; and in the upper-most line, the operational variables used for reflecting the performance are listed. In the lower part of the chart, computational over-all performance details, at system level, are presented. A significant performance number is the efficiency of water extraction (expressed by Watt*Hour/Liter water) shown in the box encircled with thick black line, which is in this example 359.3 Watt*Hour/Liter of water.

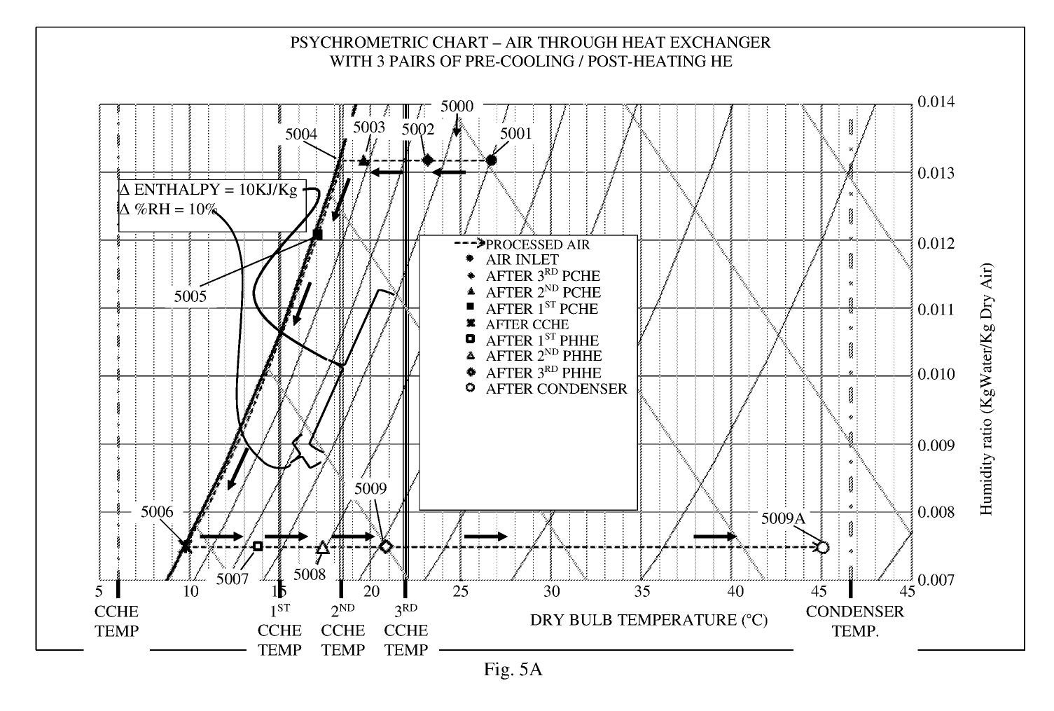

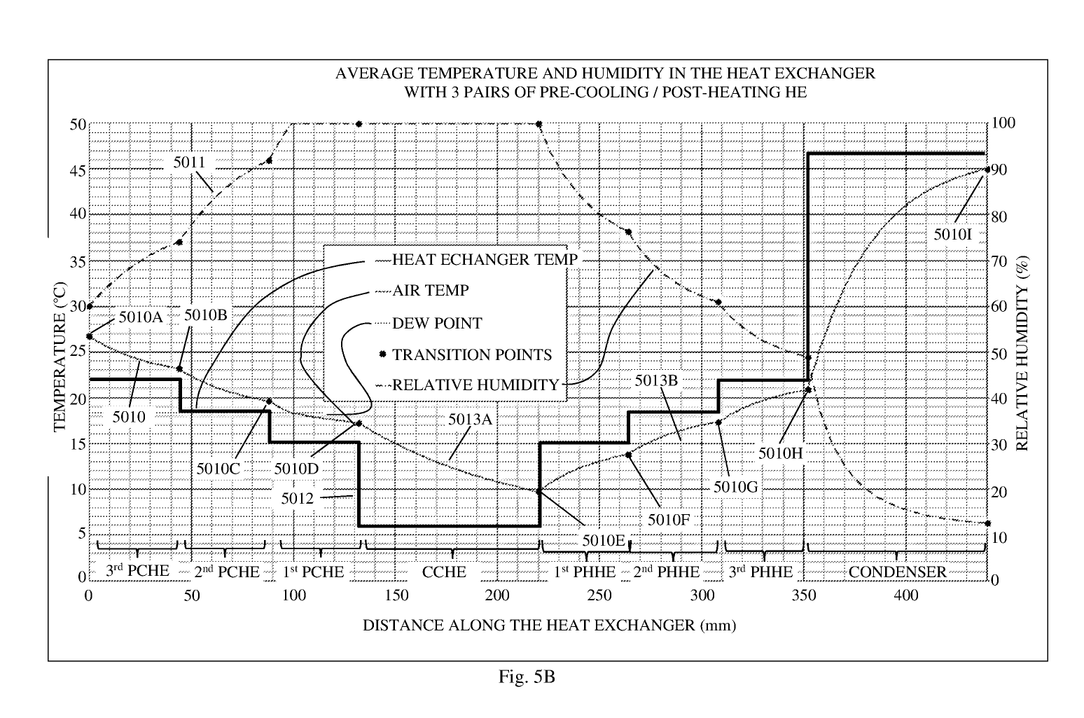

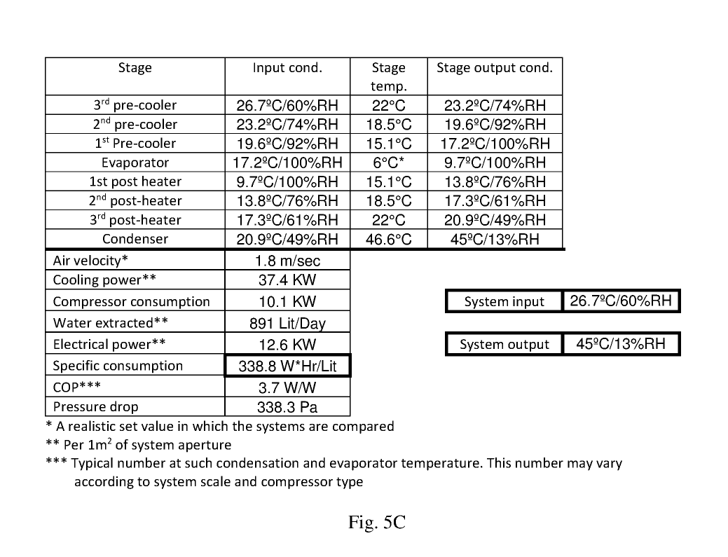

Reference is made now to FIG. 5A, which is a psychrometric chart presenting some physical characteristic of the air flowing through a dehumidifier with cooled core unit, condenser unit and three pairs of pre-cooler and post-heater, according to some embodiments of the invention. Reference is also made to FIG. 5B which depicts a temperature and humidity distribution along a dehumidifier described in FIG. 5A and to FIG. 5C, which is a chart presenting the performance of the dehumidifier described in FIG. 5A.

The graph of FIG. 5A describes the changes in temperature and humidity of air flowing through the dehumidifier. The horizontal axis represents dry bulb temperature in stages of 5° C. Meaningful temperatures are marked on the horizontal line: the CCHE temperature (set to be 6° C.); the first CCHE/PHHE pair temperature (approx. 15.1° C.); the second CCHE/PHHE pair temperature (approx. 18.5° C.), the third CCHE/PHHE pair temperature (approx. 22° C.), and the condenser temperature (approx. 46.6° C.). The vertical axis shows the humidity ratio of water, i.e., how many kilograms of water vapor exist in one kilogram of dry Diagonal lines across the chart from top-left to bottom-tight describe lines of equi-enthalpy in a difference of 10 KJ/Kg between every two adjacent lines. The curved lines crossing the chart from top-right to bottom-left represent lines of relative humidity in a difference of 10% between each two adjacent lines. The left-most relative humidity line (bold line) represents the line of dew point.

As may be seen, the changes in temperature and humidity of the air flowing through the dehumidifier are represented by dashed line 5000 that begins at point 5001, where the air enters the dehumidifier. During the cooling, the specific content of water remains constant (approx. 0.0132 Kg water/Kg Air). The air flows through the third CCHE leaving at 23.2° C./74% RH (point 5002) and enters the second PCHE. The air leaves the second PCHE at 19.6° C./92% RH (point 5003) and flows through first CCHE. Within first CCHE, the air average temperature crosses point 5004 where it reaches dew point, and proceeds to cool down until it leaves the first PCHE at 17.2° C. (point 5005). The air then enters the CCHE where it cools down to 9.7° C., and the humidity ratio drops to approx. 0.0075 (Kg water/Kg Air) as the air leaves the CCHE. The airflow leaves the CCHE (point 5007) and flows through first PHHE where its temperature start rising and reaches 13.8° C. with 76% RH (point 5007). From there, it flows through the second PHHE where its temperature rises up to 17.3° C. with 61% RH (point 5008). From there, the air flows through the third PHHE where its temperature rises up to 20.9° C. with 49% RH (point 5008). From there, the air flows through the condenser where its temperature rises to about 45° C. with 13% RH (point 5009A), and the air leaves the dehumidifier at that point.

In FIG. 5B, the horizontal axis describes locations along the air duct of the dehumidifier starting from left at the inlet and ending on the right at its outlet. The vertical left axis represents temperature (ranging from 0° C. to 50° C.). The vertical right axis represents relative humidity ranging from 0% to 100%. Graph 5010 (thin dotted line running between points 5010A-5010I) presents the changes of temperature of the air as it flows through the dehumidifier; graph 5011 presents the changes in the humidity of the air as it flows through the dehumidifier; and graph 5012 presents the temperature distribution of heat exchangers along the dehumidifier. The temperature of the third PCHE/PHHE is about 22° C. The temperature of the second PCHE/PHHE is about 18.5° C. The temperature of the first PCHE/PHHE is about 15.1° C. The temperature of the CCHE set to be 6° C. The temperature of the condenser is about 46.6° C.

Air enters the dehumidifier (point 5010A) at temperature of about 26.7° C. and its temperature drops gradually to temperature of about 22° C. (point 5010B) as it leaves the third PCHE and flows to the second PCHE and then flows to the first PCHE. The temperature reaches the dew point between point 5010C and 5010D. The air flow flows through the CCHE, and the temperature continues to drop until it reaches about 9.7° C. (point 5010E). The air leaves the CCHE and flows through the first, second and third PHHEs (through points 5010E, 5010F, 5010G and 5010H), and its temperature rises to about 20.9° C. From here, the air flows through the condenser from point 5010H to point 50101 and its temperature raises to about 45° C. where the air leaves the dehumidifier. The relative humidity, graph 5011, rises accordingly from about 60% at the entrance, to about 74% when the air flows from the third PCHE to the second PCHE, to about 92% when the air flows from the second PCHE to the first PCHE and then rises further to 100% before the air flows through the CCHE and remains 100% until the air leaves the CCHE. The relative humidity drops to about 76% as the air flows through the first PHHE, to about 61% as the air flows through the second PHHE and then to about 49% as it flows through the third PHHE and to 13% when it leaves the condenser.

FIG. 5C presents the performance of a dehumidifier with CCHE (evaporator), three pairs of PCHE/PHHEs and a condenser (that was presented in FIGS. 5A and 5B). In this chart, the upper half (the one above the thick black line) depicts operational information per stages in the dehumidification apparatus: in the vertical left-most column, the various stages of the dehumidification apparatus are listed; and in the upper-most line the operational variables used for reflecting the performance are listed. In the lower part of the chart, computational over-all performance details, at system level, are presented. A significant performance number is the efficiency of water extraction (expressed by Watt*Hour/Liter water) shown in the box encircled with thick black line, which is in this example 338.3 Watt*Hour/Liter of water.

The dehumidification apparatus according to some embodiments of the present invention aims to provide highly improved specific consumption results, therefore these resulting figures may be used as reference numbers for evaluating the performance of dehumidification systems according to embodiments of the present invention.

Although air flow rate in all four systems is the same, the evaporator temperature is the same, and the condenser temperature is almost the same, one can see from comparing FIGS. 2C, 3C, 4C and 5C that addition of pairs of PCHE-PHHE increases the water extraction and reduces the energy consumption. According to some embodiments of the present invention, the energy absorbed from the air by each PCHE is almost equal to the energy provided to the air by its paired PHHE, as demonstrated by the isenthalpic lines in FIGS. 3A, 4A and 5A.

Although specific energy consumption is reduced as pairs of PCHE/PHHE are added, as indicated above, the overall improvement is limited. If too many pairs of PCHE/PHHE units are added, the energetic saving they provide may be lower than the energy consumption of the coolant circulation pumps together with the added blower consumption. Adding pairs of PCHE/PHHE units also affects the size of the dehumidifier and its price. Thus, optimization of the dehumidifier according to some embodiments of the present invention may take into account these parameters, giving the right weight to each limiting variable according to the specifications of a given installation.

It was found, according to some embodiments of the invention, that a wide range of coolant flow rate can ensure proper operation of the dehumidifier. Accordingly, for a dehumidifier according to some embodiments of the present invention that is operating at or close to its optimal work point (that is lowest possible Watt*Hour/Liter water), large changes in the coolant flow rate will have very little effect.

A dehumidifier built and operative according to some embodiments of the present invention was proved to be linearly scalable upwardly as a function of the dehumidifier's air path cross section area (aperture). For a given number of pairs of PCHE/PHHE units and a given aperture air velocity, expending the dehumidifier aperture along with the compressor capacity, the heat exchangers aperture and the coolant pumps capacity, the dehumidifier will maintain operating at the working point with almost the same Watt*Hour/Liter of water and with amount of extracted water per hour that almost linearly grows with the aperture area.

The performance of dehumidifier built and operative according to some embodiments of the present invention may be compared to that of a counter-flow heat exchanger, in that that in dehumidifier according to the invention the heat exchange is performed gradually temperature-wise, similarly to the heat exchange done in a counter-flow heat exchanger.

For a given dehumidification apparatus with a given coolant compressor feeding the cooled core heat exchanger, a given aperture size and a given number N of stages of pairs of pre-cooling and post-heating heat exchangers, where N≥2, the operation parameters with which the dehumidification apparatus may be set to its optimal working conditions are the actual cooling power of the cooled-core heat exchanging (the capacity and temperature of the provided coolant) and the air flow rate through the dehumidification apparatus. In order to best control the operation of a dehumidification apparatus structured and operative according to some embodiments of the present invention, temperature sensors may be disposed to indicate the temperature at each pre-cooling and post-heating stage, the temperature and relative humidity at the inlet of the dehumidification apparatus and at the cooled-core heat exchanger, the air flow rate, the power provided to the fan motivating the air thorough the dehumidification apparatus and the rate of water extraction from the air.

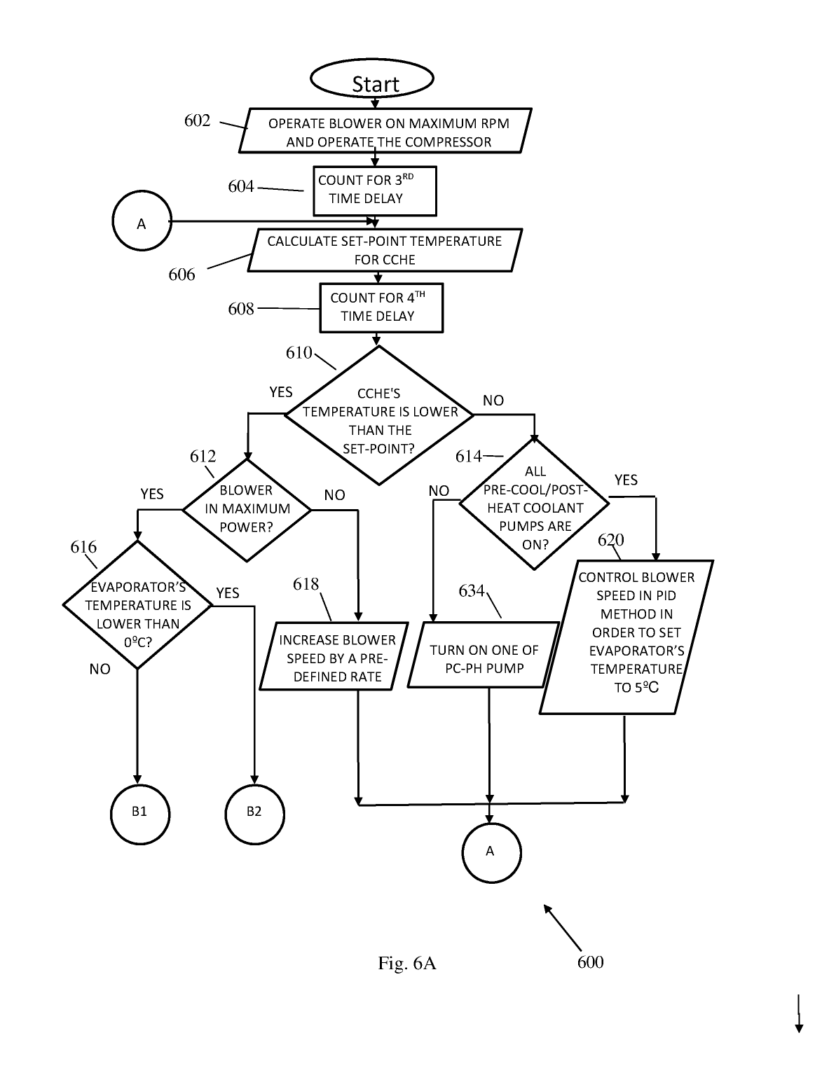

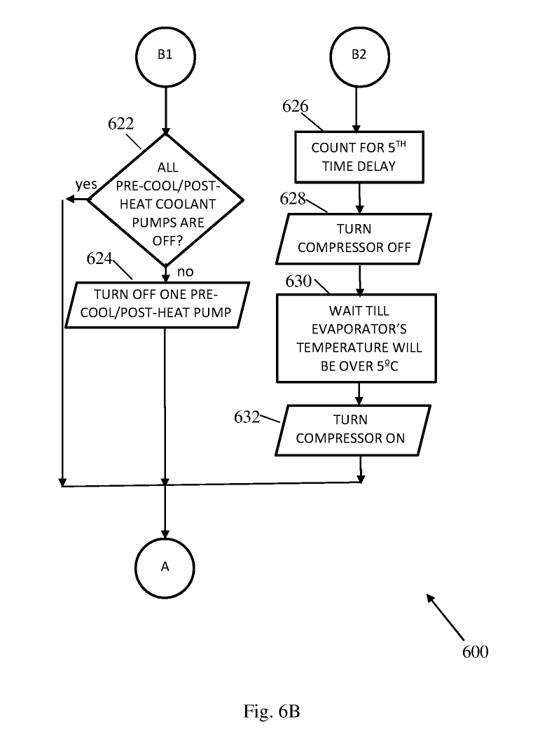

One method for controlling the operation of a dehumidification apparatus structured according to some embodiments of the invention is depicted in FIGS. 6A and 6B, which are two complementary parts of a control flow diagram 600, according to some embodiments of the present invention, to which reference is now made. The method depicted in FIGS. 6A-6B enables to operate a dehumidifier with two or more stages of pre-cooling and post-heating units, with constant compressor cooling rate and changeable air flow-rate.

As a first step, at block 602, operate the blower in full power, and operate the compressor a few second later. At block 604, a third time delay T_{D3} is applied to allow the system to get into balance. At block 606, the set-point temperature of the CCHE is calculated to yield best performances, at given known ambient air conditions. A fourth time delay T_{D4} is applied at block 608 before arriving at decision point 610 where the temperature at the CCHE is checked whether it is lower than the set point. If it is lower than the set point [YES], the control flow is directed to decision point 612 where it is checked whether the air motivating blower is operating in its maximum power. If it is operating in its maximum power [YES], the control flow is directed to decision point 616, where it is checked whether the CCHE temperature is lower than 0° C. If it is not lower than 0° C. [NO], the control flow is directed to decision point 622 where it is checked whether pre-cooling/post heating circulation pumps are off. If all of the pumps are off [YES], the control flow returns to block 606 to perform another control loop. If at least one pump is on [NO], the control flow is directed to block 624 to turn off one pump and then proceeds to block 606 to perform another control loop. If, at decision point 616 it is detected that the temperature at the CCHE is lower than 0° C. [YES], the control flow is directed to block 626 where a fifth time delay (TD₅) is applied before, at block 628, the compressor is turned off, at block 630 the control process waits until the temperature at the CCHE rises above 5° C., at block 632 the compressor is restarted and the control flow returns to block 606 to perform another control loop.

If, at decision point 612, it is detected that the air motivating blower is not operating in its maximum power [NO], a command is given at block 618 to increase the rotational speed of the blower by a pre-defined amount, and the control flow returns to block 606 to perform another control loop.

If, at decision point 610, it is detected that the temperature at the CCHE is not lower than the pre-defined value [NO], the control flow is directed to decision point 614 where it is checked whether all of the pre-cooling/post-heating pumps are operating. If not all of the pumps are operating [NO], the control flow is directed to block 634 where a command is given to turn one of the pre-cooling/post-heating pumps, and the control flow returns to block 606 to perform another control loop. If, at decision point 614, it is checked that all of the pre-cooling/post-heating pumps are turned on [YES], the rotational speed of the air motivating blower is controlled, for example using a PID control loop (or similar), in order to reach the set-point temperature of the CCHE, and the control flow returns to block 606 to perform another control loop.

Setting the target parameters of operation for a given dehumidification apparatus in a given location may be done based on measured ambient conditions, measured air pressure drop at filters (if installed) of the apparatus and then setting the control parameters according to pre-prepared chart that may be calculated empirically.

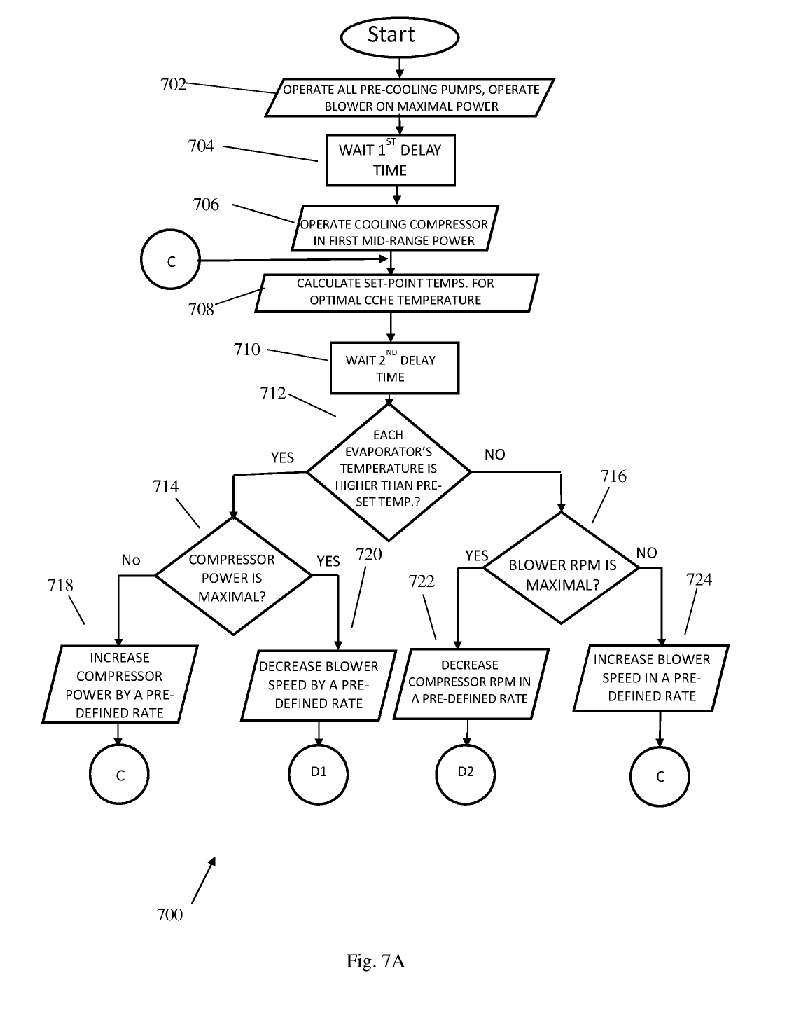

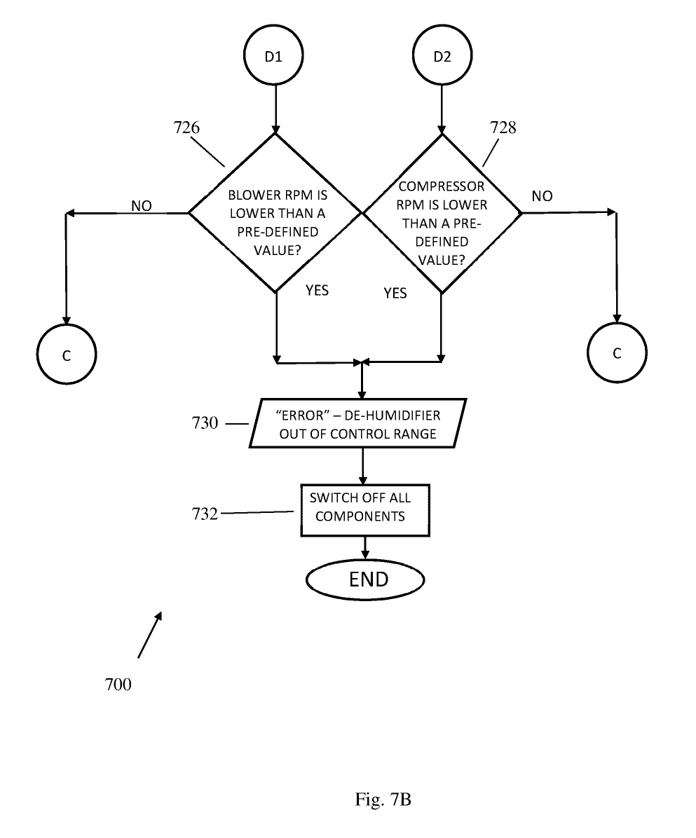

Another method for controlling the operation of a dehumidification apparatus structured according to some embodiments of the invention is depicted in FIGS. 7A and 7B, which are two complementary parts of a flow diagram 700, depicting an example of a method for controlling the operation of a dehumidification apparatus according to some embodiments of the present invention, such as dehumidification apparatus 100 of FIG. 1A. The method depicted in FIGS. 7A-7B relates to the operation of a dehumidifier with two or more stages of PCHE-PHHE units constructed and operated as described above. Flow diagram 700 can be used to control a dehumidifier with changeable compressor cooling rate and changeable air flow-rate

At block 702, the process begins by operating coolant fluid circulation pumps of all stages, and operating the blower on its maximal flow rate. A first delay time T_{D1} is applied from the operation of the coolant pumps at block 704 before starting the compressor, and at block 706 the compressor is started at a predefined mid-range power. The time length of T_{D1} depends on various parameters and variables and may be determined according to the inherent time constants of the dehumidification apparatus and according to the ambient conditions. At this step, block 708, the set-point temperature of the CCHE is calculated to yield best performance, at given known ambient air conditions. After the temperature was set, a second time delay T_{D2} is applied at block 610 before checking, at decision point 612, whether the temperature at each of the CCHE is higher than the respective set-point temperature. If the temperature of at least one of the post-heating heat exchangers is higher than the respective set-point [YES], the flow of the process is directed to decision point 714 where it is checked whether the compressor is operating at its maximum power. If it is not at its maximum power [NO], the flow is directed to block 718 where a command is given to the compressor to increase power by a predefined amount, and the control process flow returns to block 708 to perform another loop of control process.

If, at decision point 712, it is detected that the temperature of the CCHE is lower than their respective set-points [NO], the flow of the process is directed to decision point 716 where it is checked whether the air motivating blower is working at its maximum power. If it is not [NO], at block 724 a command is given to the blower to increase its rotation speed, and the control process flow returns to block 708 to perform another loop of control process.

If, at decision point 714, it was detected that the external coolant compressor is operating at maximum power [YES], a command is given, at block 720, to the air motivating blower to decrease its rotational speed by a predefined rate and the flow of the process is directed to decision point 726 where it is checked whether the rotational speed of the blower is lower than a pre-defined low-limit rotational speed. If the rotational speed of the blower is not below the pre-defined low-limit rotational speed [NO], the control process flow returns to block 708 to perform another loop of control process.

If, at decision point 616 it was detected that the rotational speed of the air motivating blower is at its maximum speed [YES], the flow of the control process is directed to block 722 where a command is given to the coolant compressor to decrease its power, and then to decision point 728 where it is checked whether the compressor is operating at a power lower than a pre-defined low limit power. If it is not [NO], the control process flow returns to block 710 to perform another loop of control process.

If, at decision point 726, it was found that the rotational speed of the blower lower than its pre-defined low limit [YES], the meaning is that the control parameters of the dehumidification apparatus has reached their limitations without being able to operate the dehumidification apparatus to reach its operating point, and an error state is declared at block 730 Similarly, if at decision point 728, it was found that the coolant compressor has reached its power lower limit [YES], the meaning is similar—the control process is out of the operating limits, and an error state is declared at block 730. Following the declaration of an error state, the dehumidification apparatus may be switched off at block 732.

It will be apparent to those skilled in the art that the control processes depicted in FIGS. 6A-6B and 7A-7B are examples only and many other variations of the control process may be applied to control the operation of a dehumidification apparatus structured according to some embodiments of the present invention. For example, where the air-motivating blower is not present (for example in case when the dehumidification apparatus is installed at a location where winds are strong and electricity is expensive so that the air is motivated spontaneously), the control process will be changed accordingly, leaving the compressor power as a single control parameter.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A dehumidifier apparatus comprising:
a duct to direct an air flow, with an air inlet and an air outlet;
a cooled core heat exchanger located within said duct and cooled by an external cooling fluid;
at least a first pre-cooling heat exchanger located upstream of said cooled core;
at least a first post heating heat exchanger located downstream of said cooled core;
at least a second pre-cooling heat exchanger located upstream of said first pre-cooling heat exchanger with an average temperature higher than an average temperature of said first pre-cooling heat exchanger;
at least a second post heating heat exchanger located downstream of said first post heating heat exchanger with an average temperature higher than an average temperature of said first post-heating heat exchanger;
a coolant circulation loop comprising a motivating means and connecting said at least first pre-cooling heat exchanger and said at least first post- heating heat exchanger;
a coolant circulation loop comprising a motivating means and connecting said at least second pre-cooling heat exchanger and said at least second post-heating heat exchanger;
a first heat exchanging fluid designated to flow from said first pre-cooling heat exchanger, adapted to convey heat absorbed in the first pre-cooling heat exchanger toward the first post heating heat exchanger, to emit heat in the first post heating heat exchanger and to flow back to the first pre-cooling heat exchanger; and
a second heat exchanging fluid, designated to flow from said second pre-cooling heat exchanger adapted to convey heat absorbed in the second pre-cooling heat exchanger, toward the second post heating heat exchanger, and to emit heat in the second post heating heat exchanger, and to flow back to the second pre-cooling heat exchanger;
at least one of the pre-cooling and post cooling heat exchangers comprising a fluid compensation tank and a bleeding assembly;
the bleeding assembly comprising an air trap cavity and an air bleed pipe, wherein the air trap cavity is connected to the coolant circulation loop, and to the air bleed pipe, the air bleed pipe is connected to the fluid compensation tank, the compensation tank comprising air bleeding means connection with a tube to the coolant circulation loop and coolant fluid, said tube allowing the coolant to flow from and toward the compensation tank.

2. The dehumidifier apparatus of claim 1 wherein at least one of the motivating means second heat exchanging fluids is one of a pump, a blower and a compressor.

3. The dehumidifier apparatus of claim 1 further comprising a fan to motivate air through said duct.

4. The dehumidifier of claim 1 wherein at least one of the first and second heat exchanging fluid is a refrigerant which is adapted to boil in a pre-cooling heat exchanger and to liquefy in the corresponding post-heating heat exchanger.

5. The dehumidifier of claim 1 wherein at least one of the heat exchangers is of the tube-and-fins type.

6. (canceled)

7. (canceled)

8. The dehumidifier of claim 1 wherein the external cooling fluid source is a vapor-compression refrigeration system wherein the condenser of said vapor-compression refrigeration system is located downstream said second post-heating heat exchanger.

9. The dehumidifier of claim 1 further comprising collection sump located at least below the cooled core adapted to collect water extracted from the air in the dehumidifier.

10. A method for dehumidifying air comprising:
urging air via a second pre-cooling heat exchanger, then through a first pre-cooling heat exchanger whose average temperature is lower than an average temperature of said second pre-cooling heat exchanger;
flowing the air from said first pre-cooling heat exchanger through a cooled core heat exchanger;
flowing the air from the cooled core heat exchanger through first post-heating heat exchanger, then through second post-heating heat exchanger;
wherein the second pre-cooling heat exchanger and the second post-heating heat exchanger are connected in a second heat exchanging fluid loop, which flows from the second pre-cooling heat exchanger to the second post-heating heat exchanger and back, and
wherein the first pre-cooling heat exchanger and the first post-heating heat exchanger are connected in a first heat exchanging fluid loop, which flows from the first pre-cooling heat exchanger to the first post-heating heat exchanger and back and further wherein at least one of the first and second heat exchanging fluid loops comprises an air bleeding assembly as defined in claim 1.

11. The method of claim 10 wherein the urging of the air is by a fan.

12. The method of claim 11 wherein at least one of the external cooling fluid and any of the first and second heat exchanging fluids is motivated in the heat exchanging fluid loop by one of a pump and a compressor.

13. The method of claim 10 wherein the heat exchanging fluid is a refrigerant which is adapted to boil in a pre-cooling heat exchanger and to liquefy in the pair post-heating heat exchanger.

14. The method of claim 10 wherein at least one of the heat exchangers is of the tube-and-fins type.

15. The method of claim 10 further comprising compensating volumetric changes in the heat exchanging fluid by means of a heat exchanging fluid storage compensation tank.

16. The method of claim 10 wherein the cooled core heat exchanger is cooled by vapor-compression refrigeration system, which its condenser is located downstream the second post-heating heat exchanger.

17. The method of claim 10 further comprising collecting at least some of the extracted water in the dehumidifier using a water sump.

18. The dehumidifier of claim 1 further comprising a central controller comprising control units each controlling the flow rate of the coolant in a heat exchanging loop comprising the pre cooling and post heating heat exchanger.

19. The method of claim 10 further comprising controlling the flow rate of the coolant in the heat exchanging loops.
